(19) United States
(12) Patent Application Publication
(10) Pub. No.: US 2008/0036595 A1
(43) Pub. Date: Feb. 14, 2008

(54) SELF-CONTAINED SECURITY SYSTEM

(75) Inventors: David Stuart Hollstien, Templeton, CA (US); Michael Ray Hanson, Atascadero, CA (US)

Correspondence Address: SHELDON MAK ROSE & ANDERSON PC, 100 East Corson Street, Third Floor, PASADENA, CA, 91103-3842, US

(73) Assignee: TRIDENT SECURITY CONCEPTS, LLC, Templeton, CA (US)

(21) Appl. No.: 11/837,443

(22) Filed: Aug. 10, 2007

Related U.S. Application Data
(60) Provisional application No. 60/813,622, filed on Aug. 11, 2006.

(51) Int. Cl. G08B 13/00; G08B 21/00; G08B 23/00

(52) U.S. Cl. 340/541; 340/636.2; 340/693.1; 340/693.5

(57) ABSTRACT

A portable, self-contained security system for protecting an object external to the system, the system comprising one or more sensors and one or more alarms to draw attention to the unit if the sensors are activated.

The present application claims the benefit of priority from U.S. Provisional Patent Application No. 60/813,622, filed Aug. 11, 2006 and titled “Self-Contained Security System,” the entire disclosure of which is hereby incorporated by reference.

### BACKGROUND

Electronic security systems use a variety of sensors to detect intruders or dangerous conditions. Such sensors include passive infra-red motion sensors, microwave sensors, accelerometers, electric field detectors, thermal sensors, smoke detectors, and optical cameras.

Traditional security systems are permanently installed in a home or building. The installation often includes sensors distributed throughout the structure which are wired to a control console that is also connected to a siren or alarm bell. These types of systems are routinely connected to a central office via a telephone link so that the proper authorities can be notified if the alarm system is activated.

Recently, wireless security systems have become available. These are similar to wired systems in that the sensors are distributed through a structure. The sensors themselves contain a radio link that allows them to communicate with a control console without physically connecting them with wires. This makes the initial installation much simpler. However, the sensors often contain a battery that must be replaced periodically.

Permanently installed outdoor lights are often fitted with passive infra-red motion detectors. The lights are turned on when the sensors detect motion within a region defined by the orientation of the installed sensor. At night, these devices are very effective in deterring intruders by exposing them as they approach.

Vehicle alarm systems are permanently wired into the electrical system of the vehicle to be protected. A variety of sensors are used, but usually the vehicle horn is used for the audio alarm. It is common to use a hand-held key fob remote to arm and disarm a vehicle alarm system.

### SUMMARY

The present invention is a self-contained, portable security system that houses numerous sensors as well as a flashing beacon and a high-intensity siren. The device can be installed simply by placing it on or around valuable objects that require protection. The unit can be set up instantly since no wiring or placement of sensors is required. The system is advantageously armed and disarmed using a familiar key fob remote. The unit can be used indoors, but is rugged and weather resistant to withstand prolonged use outdoors.

In one aspect, the present self-contained, portable security system comprises a housing unit which includes a housing, a plurality of sensors in the housing for detecting an intruder within a security region around an object exterior to the housing, and one or more alarms, particular visual and audible alarms. The sensors can include an infra-red sensor, an accelerometer, a microwave motion sensor, an electric field detector, a thermal sensor, and/or a video camera. The alarms can preferably be disarmed remotely by an electronic key fob.

In this embodiment, the sensors are preferably positioned in an upper portion of the housing, and the center of gravity of the security system is in a lower portion of the housing, in order to provide greater stability to the security system. A clamp mount for coupling the housing to an object, such as an object to be protected, can also be provided on the housing, as can a handle for ease of transport. The handle can be reversibly secured to the housing.

In a further embodiment, the sensors of the security system can include a first infra-red motion sensor having a first detection region extending outward from a front face of the housing and a second infra-red motion sensor having a second detection region extending outward from a rear face of the housing.

The electronic key fob can include an indicator of the activation status of one or more of the sensors, which can be communicated from the housing unit to the remote key fob via a radio frequency communication link or an infra-red communication link. The electronic key fob preferably automatically disarms the alarms when it is within a predetermined distance from the housing unit, and also preferably includes an indicator of whether a second security system is within radio communication range as well of the activation status of a sensor of the second security system.

In another aspect, the present portable security system comprises one or more sensors, one or more alarms triggered by the sensors, a battery, and a housing containing the sensors, the alarms and the battery. The system in this embodiment further includes a battery holder for retaining the battery in a lower portion of the housing, with the interior surface of the battery holder engaging at least the upper surface and the side surfaces of the battery. A plurality of ribs extending between the interior surface of the housing and the exterior surface of the battery holder is also provided to restrain movement of the battery within the housing. One or more of the ribs is preferably attached to the interior surface of the housing and extends inwardly from the interior surface of the housing, and fastener for fastening the battery holder to the housing can be provided.

In this embodiment, the sensors can include an accelerometer, a microwave motion sensor, an electric field detector, a thermal sensor, a smoke detector, and a video camera. The sensors are preferably positioned in an upper portion of the housing, as is a visual alarm. Elastomeric feet are also preferably provided on a lower surface of the housing.

In a further aspect, the present portable security system can comprise one or more sensors, a housing for containing the sensors, a beacon located on the top of the housing between the two lateral sides of the housing so that the beacon can be visible from both the front face and the rear face of the housing when activated, and a rigid handle extending over the beacon and between the two lateral sides of the housing to protect the beacon from an impact. The sensors can include an accelerometer, a microwave motion sensor, an electric field detector, a thermal sensor, a smoke detector, and a video camera. The beacon is also preferably protected by a translucent cover. The system in this embodiment also preferably has a center of gravity in a lower portion of the system. In another aspect, the present portable security system comprises a housing having a front face and a rear face, a first infra-red motion sensor having a first detection region extending outward from the front face of the housing, and a second infra-red motion sensor having a second detection region extending outward from the rear face of the housing, The first detection region and the second detection region are preferably asymmetric, an the front face and rear face of the housing preferably extend approximately vertically from a support surface supporting the housing. In this embodiment, the system can include one or more visual and/or audible alarms, and the system can further include an accelerometer, a microwave motion sensor, an electric field detector, a thermal sensor, a smoke detector, and/or a video camera.

A further aspect of the present invention is a method of using a security. In this method, a first portable security system and a second portable security system are provided, each system comprising a housing, a plurality of sensors in the housing for detecting an intruder within a security region around an object exterior to the housing, the sensors being selected from the group consisting of an infra-red sensor, an accelerometer, a microwave motion sensor, an electric field detector, a thermal sensor, and a video camera, and one or more alarms in the housing selected from the group consisting of a visual alarm and an audible alarm. When one or more sensors of the first security system are activated, an alarm of the first security system is activated, and a communication signal is transmitted directly from the first portable security system to the second portable security system to activate an alarm of the second portable security system. Preferably, the transmission occurs only if more than one sensor of the first portable security system is activated.

In another aspect, a method of using a security system is provided. In this method, a portable security system is provided, the system comprising a housing, a plurality of sensors in the housing for detecting an intruder within a security region around an object exterior to the housing, the sensors being selected from the group consisting of an infra-red sensor, an accelerometer, a microwave motion sensor, an electric field detector, a thermal sensor, and a video camera, and one or more visual and/or audible alarms. When one or more sensors of the first security system are activated, a communication signal is sent from the portable security system to a status notification server, and the status notification server generates generating a message in response to the communication signal from the portable security system. The message is then sent to a user of the portable security system. In this method, the communication signal from the portable security system to the status notification server can be sent via a cellular communications network or a two-way pager base station, for example. The message can be an audible message generated by a speech generator or a text message, and the message can be sent via a telephone network that may include wired or cellular telephones. The message can also be sent via electronic mail or an electronic pager.

According to one embodiment of the present invention, there is provided a microwave sensor comprising a) a transmitter, b) an antenna connected to the transmitter, c) an amplitude detector electrically connected to the antenna, d) a band pass filter electrically connected to the amplitude detector and c) a microprocessor interface electrically connected to the transmitter, the antenna, the amplitude detector and the band pass filter. In another embodiment, the microprocessor interface comprises an analog to digital converter. In another embodiment, the transmitter and the antenna, transmit microwave detection signals, transmit communications signals or both transmit microwave detection signals and transmit communications signals. In another embodiment, the transmitter is pulsed at a rate at least between 80 pulses a second and 1000 pulses a second. In a preferred embodiment, the transmitter is pulsed 400 pulses per second.

In one embodiment, the antenna is selected from the group consisting of a dielectric resonator antenna, a dipole antenna, an electrically short antenna, a feed horn antenna, a helical antenna, a large loop antenna, a microstrip antenna, a parabolic antenna, a phased array antenna and a small loop antenna. In another embodiment, microwave frequency received by the antenna is continuous wave. In another embodiment, the microwave frequency received by the antenna is between 900 Mhz and 6 Ghz. In a preferred embodiment, the microwave frequency received by the antenna is 900 Mhz. In another embodiment, the microwave frequency received by the antenna is pulsed. In another embodiment, the microwave frequency received by the antenna comprises a pulse repetition frequency between 10 and 1000 pulses per second. In a preferred embodiment, the microwave frequency received by the antenna is 400 pulses per second.

In one embodiment, the amplitude detector and the band pass filter sum the frequency received by the antenna and output an amplitude modulated signal. In another embodiment, the microprocessor interface sums a digital sample frequency with a received digitally converted microwave frequency. In another embodiment, the band pass filter is activated when an amplitude modulated signal received from the antenna is greater than 900 MHz. In another embodiment, the band pass filter outputs an alternating current between 1 VAC and 12 VAC. In another embodiment, the band pass filter outputs a direct current between 1 VDC and 12 VDC.

In one embodiment, there is provided a battery charging and communications circuit comprising a) an accessory detection unit; b) a voltage control unit electrically connected to the accessory detection unit; c) a power and data switching unit electrically connected to the voltage control unit; and d) a battery. In another embodiment, the accessory detection unit transmits data to one or more detected accessories attached to the circuit. In another embodiment, the accessory detection unit receives data from one or more detected accessories attached to the circuit. In another embodiment, the accessory detection unit transmits power to one or more detected accessories attached to the circuit.

In one embodiment, the voltage control unit supplies an input voltage, an input current, an output voltage and an output current to the battery charging and communications circuit; and where the input voltage, the input current, the output voltage and the output current are selected from the group consisting of an externally supplied alternating current, an externally supplied direct current and an internally supplied direct current. In another embodiment, the voltage control unit limits the input current and output current to 7 amperes. In another embodiment, the voltage control unit recharges the rechargeable battery and operates the circuit. In another embodiment, the voltage control unit supplies a constant input current to the battery of 700 mA until the applied voltage to the battery is 14.75 volts. In another embodiment, the voltage control unit supplies a constant 14.75 volts to the battery until the applied current to the battery is 70 mA. In another embodiment, the voltage control unit supplies a constant voltage is 13.65 volts to the battery when the applied current to the battery is below 70 mA. In another embodiment, the voltage control unit is forward biased to select a higher input voltage to supply the circuit. In another embodiment, the voltage control unit comprises an electronic switch to select the input voltage and the input current to operate the circuit and attached accessories.

In one embodiment, the power and data switching unit is pulse width modulated to control an accessory input voltage, an accessory input current, an accessory output voltage and an accessory output current. In another embodiment, the power and data switching unit alternately transmits power and transmits data to externally connected accessories. In another embodiment, the power and data switching unit alternately receives power and receives data from externally connected accessories.

In one embodiment, the battery is rechargeable. In another embodiment, the battery is a lead-acid battery. In another embodiment,

In one embodiment, the battery charging and communications circuit further comprising a battery charge sensor. In another embodiment, the battery charge sensor measures a charge current supplied to the rechargeable battery. In another embodiment, the battery charge sensor transmits a signal to the voltage control unit when the rechargeable battery is fully charged. In another embodiment, the battery charge sensor transmits a signal to the voltage control unit when the rechargeable battery is connected to an external power source.

According to one embodiment of the present invention, there is provided a method of using a microwave sensor, the method comprising a) providing a microwave sensor; b) summing an outgoing transmitted signal frequency and a reflected signal frequency; where the sum of the outgoing transmitted signal frequency and the reflected signal frequency is equivalent to the outgoing transmitted signal frequency that is amplitude modulated by the difference between the outgoing transmitted signal frequency and the reflected signal frequency; c) subtracting the outgoing transmitted signal frequency resulting in an amplitude modulated signal where the frequency is the difference between the outgoing transmitted signal frequency and outgoing reflected signal frequency; and where the amplitude modulated signal is related to the amplitude of the reflected signal; d) receiving communications data from attached accessories; and e) processing the communications data received from the attached accessories. In another embodiment, the microprocessor interface samples an alternating current waveform from the band pass filter 10 times per cycle of the alternating current waveform where the alternating current waveform is converted from analog to digital. In another embodiment, the band pass filter passes an alarm signal when the amplitude modulated signal is between 40 Hz and 90 Hz greater than the outgoing transmitted signal frequency. In another embodiment, the microprocessor interface receives the alarm signal and activates the alarm unit. In another embodiment, the microprocessor interface receives and processes the communications data from the attached accessories; and where one or more algorithms coded in the microprocessor interface activates the alarm unit based on the received and processed communications data.

### DRAWINGS

These and other features, aspects and advantages of the present invention will become better understood with regard to the following description, appended claims, and accompanying figures.

FIG. 1 is a perspective view of the exterior of the present self-contained security system and a key fob remote.

FIG. 1A is a perspective view of the security system of FIG. 1 showing internal components of the system.

FIG. 2 is an exploded view of an embodiment of the present security system.

FIG. 2A is a sectional view of the assembled security system illustrated in FIG. 2 along line 2-2.

FIG. 2B is a front perspective view of the assembled security system illustrated in FIG. 2.

FIG. 3 is a top plan view of the present security system illustrating the directional sensitivity of the passive infra-red sensor and the omni directional sensitivity of the microwave sensor.

FIG. 4 is a side view of the security system and the vertical range of sensitivity of the passive infra-red sensor.

FIG. 5 is a perspective view of an alarm remote device.

FIG. 5A is a perspective view of an alternative embodiment of an alarm remote device.

FIG. 5B is an exploded view of the alarm remote device of FIG. 5A.

FIG. 6 is a perspective view of an automatic remote device.

FIG. 7 is a top plan view of the present security system illustrating the region around the security system where motion can be detected by a passive infra-red sensor of the system.

FIG. 8 is a top plan view of the present security system illustrating the region around the security system where motion can be detected by a passive infra-red sensor when the unit is placed near a barrier such as a wall.

FIG. 9 is an electrical diagram for the electric field sensor.

FIG. 10 is a block diagram of the microwave sensor using a communications transmitter.

FIG. 11 is a system diagram of a communications system for notifying a user that an alarm has been triggered according to one embodiment of the present invention.

FIG. 12 is a block diagram of a microwave sensor according to one embodiment of the present invention.

FIG. 13 is a block diagram of a battery charging and communications circuit 1300 according to one embodiment of the present invention.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by its intended use.

### DESCRIPTION

### Definitions

As used herein, the following terms and variations thereof have the meanings given below, unless a different meaning is clearly intended by the context in which such term is used.

“Accelerometers” are sensors that detect movement by measuring the time rate of change of velocity of the sensor, where velocity is defined as the time rate of change in position. The accelerometer is an inertial measurement device that is generally self-contained and can be constructed into an integrated circuit.

“Center of gravity” refers to the point in an object about which it is in perfect balance.

“Down” and “downward” mean in the direction of or toward a support surface on which the present system is or can be positioned. “Up” and “upward” mean in the opposite direction, i.e. away from such a support surface.

“Electric field detectors” are sensors that measure the disruption of an electric field surrounding an insulated, electrically conductive electrode. Electrodes can take the form of an insulated wire, a wire mesh, or a wire fabric. An electric field can be disrupted by the motion of a conductive object or a living being.

“Horizontal” refers to an orientation approximately parallel to (i.e., not substantially extending toward or away from) a support surface on which the present system is supported when in use.

“Key fob” is a small hardware device with built-in authentication mechanisms for remote communication and/or control of the present security system.

“Lower” refers to the relative position of a component in the present system which is closer to or toward a support surface on which the present system is positioned when in use. “Upper” refers to the relative position of a component in the present apparatus which is further from or away from such a support surface.

“Microwave motion sensors” are sensors which use a Doppler frequency shift technique to detect motion of an object. A microwave signal is transmitted from a source, and a portion of this signal is reflected by all of the objects in the vicinity of the transmitter. If the objects are stationary, the frequencies of the reflected signals are the same as the transmitted signal. If however an object is in motion, the frequency of the reflected signal is shifted slightly. This frequency shift is detectable by the sensor system.

“Optical detectors” are sensors which compare successive images captured by a camera using an algorithm and determine if the scene has changed significantly. Detection is based on a sufficient number of pixels changing from image to image. Also, the camera can be used to record an image of an intruder that can be used for identification purposes.

“Outward” means in a direction away from the horizontal or vertical center of the system or of a component part of the system.

“Passive infra-red motion sensors” (also referred to simply as infra-red sensors) are sensors that utilize a pyroelectric sensor that detects temperature differences, typically at a distance of up to 50 feet. The sensors can distinguish differences between the ambient temperature and the temperature, e.g. of a human being or an animal. A thin, plastic, lens is typically used to focus thermal radiation onto the sensor so that when a relatively hot object or person moves past the sensor the temperature change is detected.

“Smoke detectors” are sensors that measure the absorption of low level radiation by airborne smoke particles.

“Thermal sensors” are sensors that measure excessive ambient temperature that may be a result of a fire.

“Translucent” refers to a material that allows light to pass through it, including a transparent material.

“Vertical” refers to an orientation extending toward or away from a support surface on which the present system is supported when in use, preferably at an angle of about 90° with respect to the support surface.

“Video camera” denotes a camera device which captures either still video images, moving video images, or both, generally in digital format.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

Security System

Housing Components

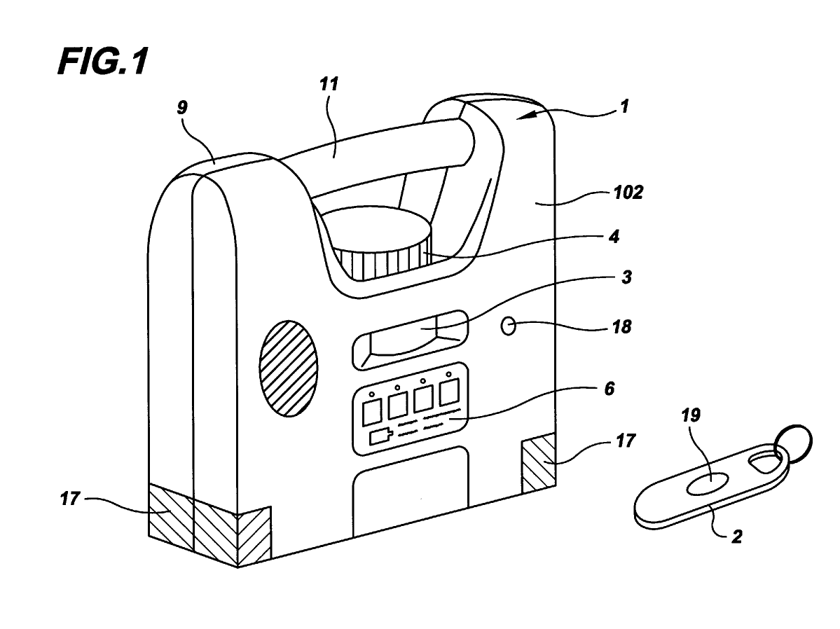

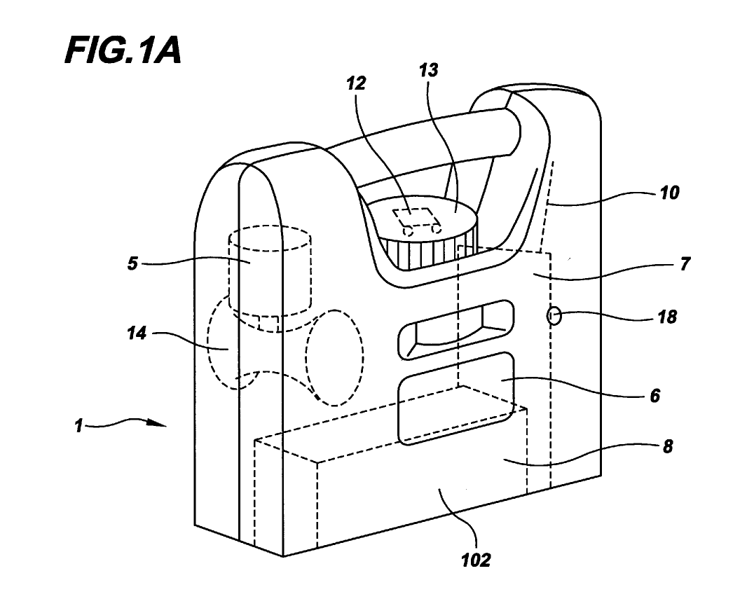

The present system 1 comprises a housing 9 generally having a front face 102, a rear face 104, an exterior surface 107, and an interior surface 109 as best seen in FIG. 2. In the embodiment shown in FIGS. 1-2A, the front face 102 and rear face 104 of the housing 9 are made from separate pieces of an injection molded plastic. The remaining components of the present security system 1 are assembled on or within the two faces of the housing 9, and the two faces are attached, such as by inserting bosses (circular rounded projections, not shown) projecting inwardly from the inner surface 109 of the front face 102 of the housing 9 into receiving cylinders 155 projecting inwardly through the inner surface 106 of the rear face 104 of the housing 9. As shown in FIGS. 2 and 2A, other components of the present security system 1 can include a passive infra-red motion sensor 3, a high intensity siren 5, a control panel 6, a battery housing 59, a rechargeable battery 8, internal electronics 7, and a flashing beacon 4, all enclosed in the housing 9 which further comprises a handle 11.

The housing 9 is preferably composed of front and back shells made of injection molded plastic, such as a ABS/polycarbonate or blend of polycarbonate and polybutadiene terephthalate, for example General Electric XENOY polymer. The plastic used for the housing 9 is stabilized for prolonged exposure to ultraviolet exposure to minimize discoloration and deterioration. A handle 11 can be preferably molded at the top of the housing 9 and can be sized to accommodate users with large hands. Alternatively or in addition, one or more handles can be positioned on the side or sides of the housing 9. In one embodiment, the handle 11 is detachable from the housing 9.

The number of water entry points in the housing 9 has been minimized to prevent water damage to internal components of the present security system 1. In the embodiment of FIGS. 1 and 1A, the opening 101 for the barrel jack 18 and openings for the acoustic waveguide 14 are the only two locations where water can enter easily. Drain holes can also be provided in the bottom surface (i.e., the lowermost surface) of the housing 9 in order to allow any water entering the housing 9 to drain out.

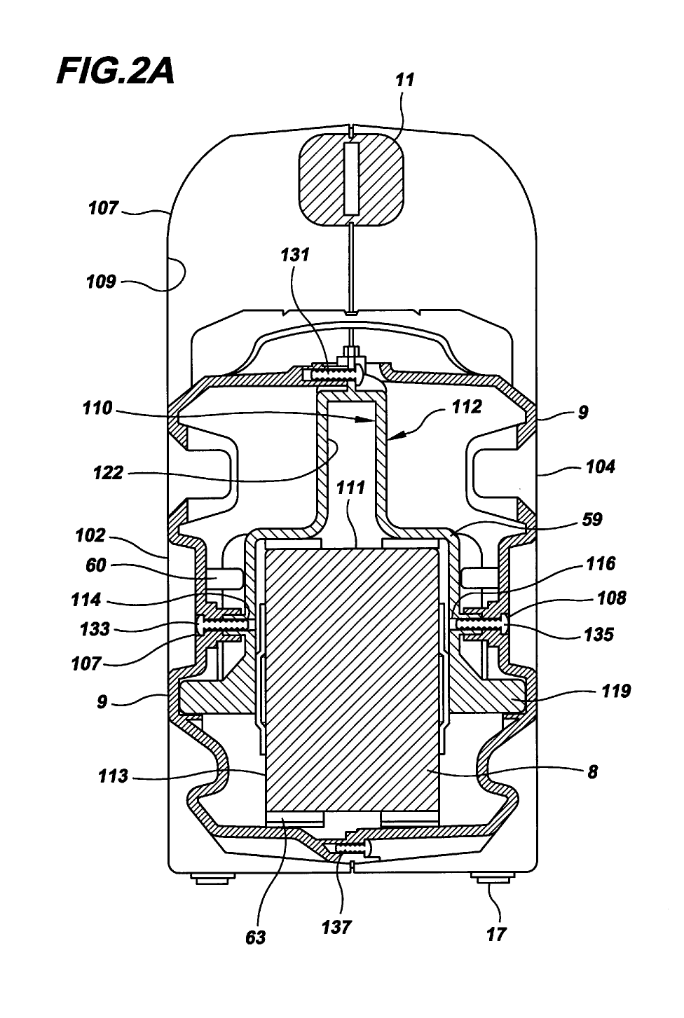

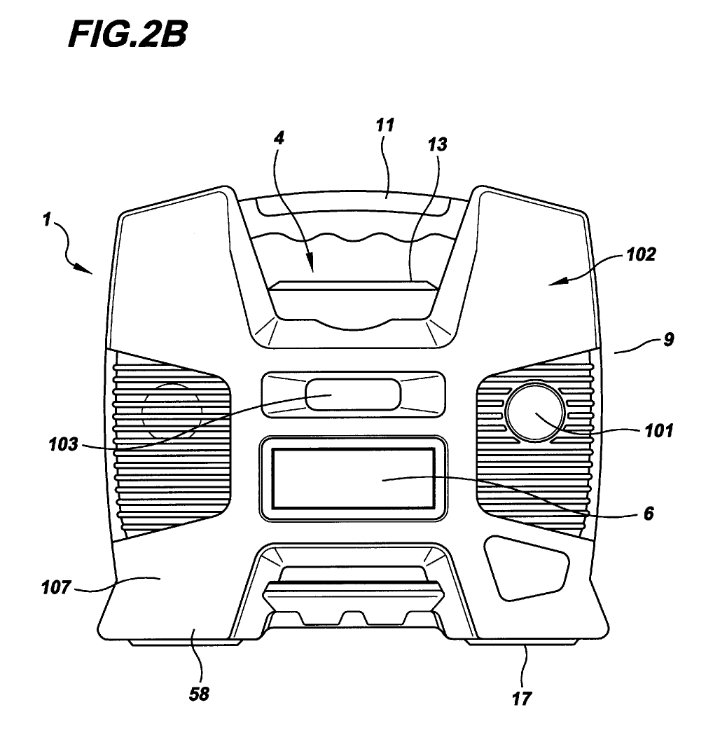

The passive infra-red motion sensor 3 is preferably oriented toward the front face 102 of the unit, and will therefore have the greatest sensitivity in this direction as shown in FIG. 3. The distance for which this sensor can detect motion is typically on the order of 25 feet and spans a 110 degree sector horizontally 15. FIG. 4 shows the preferred vertical sensitivity of such a passive infra-red sensor. In this direction it has an angular range of approximately 50 degrees.

The pyroelectric sensor portion 141 of the infra-red sensor 3 is enclosed behind a fresnel lens 143 preferably made of a thin sheet of polyethylene. Polyethylene is used because it is transparent to infra-red light. In one embodiment, a curved element 145 is placed between the fresnel lens 143 and the pyroelectric sensor portion 141. A port 147 for the sensor 3, which can be a circuit board, is preferably placed behind the pyroelectric sensor portion 141. The sensor and lens are preferably recessed into the front face 102 of the housing 9 to protect them from direct impact.

A siren 5 is preferably positioned in the housing 9 so that it directs sound downward. Pointing the siren downward helps to protect the siren from water and minimizes the potential for water intrusion into the siren itself. The siren 5 is preferably a piezoelectric-type device, such as a 120 decibel siren, that emits a directional sound output. In one embodiment, shown in FIG. 1A, sound from the siren 5 is directed into an acoustic waveguide 14 which directs the sound outwardly from both the front face 102 and the rear face 104 of the housing 9. In this way it is not necessary to have separate sirens pointing toward the front and back of the unit, respectively. Alternatively, if the siren is sufficiently loud, it can be oriented downward without a wave guide, such that the sound disperses evenly in a horizontal direction.

In the embodiment shown in FIGS. 2 and 2A, the battery 8 is a rechargeable battery located in a lower portion of the housing 9. Positioning the battery in this way allows the present security system 1 to have a center of gravity in the lower vertical portion of the housing 9, providing greater stability to the system when it is placed on a support surface. This is particularly true when the battery 8 is a lead-acid type battery, which is relatively heavy and can comprise more than half of the weight of the present system 1, preferably approximately ⅔ of the weight of the system 1. This battery chemistry was selected specifically because it is heavy, has a long life, and is very low cost. In a preferred embodiment, the battery is a 12 volt, 5 or 7 amp-hour, sealed lead-acid battery, though other battery types can also be used, such as nickel-cadmium batteries. If the mass of alternative battery types does not place the center of gravity of the present security system 1 in the lower portion of the housing 9, then the housing 9 and/or components thereof can be configured such that additional weight is moved to the lower portion of the housing 9.

The battery is held in place in the housing 9 through the use of a battery holder 59 which restrains the vertical and horizontal movement of the battery 8 within the housing 9 of the present system 1. In the embodiment shown in FIG. 2, the battery holder 59 comprises a receptacle 110 on an inner surface 122 of the battery holder 59. The receptacle 110 is configured to fit around the battery 8 and to contact or come into close proximity to (i.e., within about a centimeter of) the upper surface 111 and side surfaces 113 of the battery 8, i.e., within several millimeters of the battery. In other embodiments, structures other than a receptacle can be used. Such structures would likewise contact or come into close proximity to the upper surface 111 and side surfaces 113 of the battery 8, and can also support a bottom surface of the batter 8 as well. The battery holder 59 can be made from the same material as the housing 9, e.g. from a plastic material, but in an alternative embodiment can be formed from metal or another material.

In the embodiment shown in FIG. 2A, the battery holder 59 comprises an upper portion 112 which extends upwardly and is connected to an upper portion of the housing by means of a fastener, in this case a screw 131 which attaches the front face 102 and rear face 104 of the housing 9 to each other and to the battery holder 59 through holes present in these components of the present system 1. A central fastener 133 attaches the front face 102 of the housing 9 to the battery holder 59 by extending through a hole 107 in the front face 102 of the housing 9 and a hole 114 in a front side of the battery holder 59. A second central fastener 135 likewise attaches the rear face 104 of the housing 9 to the battery holder 59 by extending through a hole 108 in the rear face 104 of the housing 9 and a hole 116 in a rear side of the battery holder 59. A lower fastener 137 can further be used to join the front face 102 and rear face 104 of the housing 9.

Ribs 60 extending between the inner surface of the housing 9 and the outer surface of the batter holder 59 help to retain the battery 8 in position in the housing 9, help to minimize lateral movement of the batter holder 59, and contribute to the rigidity of the housing 9. In the embodiment shown in FIGS. 2 and 2A, the ribs 60 extend inwardly from the inner surfaces of the front face 102 and rear face 104 of the housing 9 toward the outer surface of the battery holder 59. Alternatively, such reinforcement ribs can be a part of the battery holder 59 and extend outwardly from the outer surface of the battery holder 59 toward the inner surfaces of the housing 9. A rim 119 extending outwardly from the lower periphery of the battery holder 59 toward the inner surfaces of the housing 9 performs an equivalent structural function in the embodiment shown in FIGS. 2 and 2A.

When the receptacle 110 of the battery holder 59 is not itself in direct contact with the battery 8, it is preferably connected to the battery, such as via battery pads 63. The battery pads 63 are preferably made from PORON cellular urethane foam which can aid in adsorbing shock when the present system 1 is dropped or otherwise subjected to impact. Elastomeric feet 17 placed on a bottom surface of the housing 9, in particular when positioned at the two longitudinal, vertical ends of the housing 9, can add further stability to the security system 1. Such elastomeric feet 17 also serve to decouple the kinetic energy of the battery from the housing and increase the resistance of the unit to damage when the unit is dropped. With position of the handle 11 at the top of the unit and the center of gravity arranged toward the bottom, the elastomeric feet 17 are positioned such that they will be the first points of contact when the security system 1 is set down on a horizontal surface. If the unit were to fall out of a user's hand, this orientation would be preserved. The elastomeric feet 17 dissipate the energy associated with the impact.

In the embodiment shown in FIG. 2, the upper portion 112 of the battery holder 59 further retains an array of high intensity LEDs 12 which function as a beacon 4. The preferred embodiment of the present security system 1 includes both an alarm siren 5 and a flashing beacon 4 to indicate that a sensor has been activated, in order to draw attention to the activity of a potential intruder or thief and cause them to abandon their efforts. The beacon 4 is preferably located in the upper portion of the housing 9, i.e. in the upper vertical half of the housing 9, and is preferably visible from both the front face 102 and the rear face 104 of the housing 9. Placement of the beacon 4 is also preferably at approximately the highest point on the unit, in order to make it easier to be seen when it is flashing. This is particularly important in low light situations, such as at night, when locating the source of an audible alarm (siren) alone may be difficult. Minimizing the number of light sources also minimizes the cost of the unit and conserves power.

The LEDs 12 provide a directional light source for use as a visible indicator for the present system. The LEDs 12 can indicate that the unit is on, is armed, and/or can indicate that an alarm has been activated. Such indication can be accomplished by assigning the foregoing states to a flashing or non-flashing signal and/or to different colored LEDs in the array 12.

Positioned around the array of LEDs 12 is a beacon cover 13. The cover 13 is translucent and preferably is transparent in order to allow the LEDs to be visible from outside the housing. The beacon cover 13 also provides physical protection to the array of LEDs 12 as well as protecting the array from exposure to rain and other sources of water. The relatively delicate, transparent plastic cap is preferably protected by the handle 11, which can be made from a material which is suitably rigid to protect the cap from impact if the unit is dropped, such as from a height of about 3 feet (1 meter), and the upper portion of the housing 9 thereby impacts a surface.

A printed circuit board 61 is also preferably attached to the battery holder 59. This is advantageous because the battery holder 59 is connected to or in close proximity to the portion of the present system having the greatest weight, i.e., the battery 8 in this embodiment, thereby providing greater stability to the printed circuit board 61. The printed circuit board 61 further holds the internal electronics 7 of the present system 1, comprising a number of electronic components including a microprocessor and, in preferred embodiments, an RF transceiver that communicates with a radio in the remote key fob 2. Sensors, such as an accelerometer and microwave motion sensor, are also preferably included in such internal electronics 7. The assembly is preferably conformal coated with a silicone based material to seal it from water and humidity. The antenna 10 can be attached to the top of the circuit assembly and can be made for example from a length of wire that is approximately 1.5 inches long. Preferably, the antenna is formed as a pattern on the printed circuit board 61. The antenna length is selected to form a monopole antenna for operation at 915 MHz. The electronics on the board also preferably contain circuitry to detect microwave signals that have reflected off of moving objects. The vertically mounted monopole antenna provides an omni directional sensitivity 16 as shown in FIG. 3.

The battery 8 is connected to the internal electronics 7, where a battery charging circuit is located. A barrel jack 18 allows a wall transformer to be connected for battery charging, and preferably also allows the present system 1 to be connected both to a power source and to accessory devices. The barrel jack 18 is associated with an opening, and also in a preferred embodiment with a magnetic disc 62 which provides a means for connecting a plug to barrel jack 18 without a mechanical locking mechanism to ensure that the plug is not easily removed from barrel jack 18. Such a connection is advantageous because if excessive force is applied to it, the power cord can become physically disconnected from the present system 1 without pulling down the housing 9 with it and potentially damaging the present security system 1.

The front face 102 of the housing 9 preferably further comprises a control panel 6. In one embodiment, the control panel can comprise controls for the security system 1, such as a button to arm and disarm the system, a button to select one or both of the passive infrared sensors, and buttons to make other selections, such as the use of other sensors in the present system 1. In this embodiment the control panel 6 is preferably a membrane-type panel that has integral LED indicators and momentary push-button switches mounted on a rigid, adhesive backed plate. Membrane switches are preferred because they are sealed from water intrusion and are inexpensive to build. However, in a preferred embodiment, such controls are only present in a key fob remote device 2, and a control panel 6 comprises only indicators, such as LED indicators of the status of the foregoing selections. The control panel 6 has a flexible cable connecting it to the internal electronics 7.

Further components of the present security system 1 can be located in the housing 9, as illustrated in FIG. 2. The lower portion of the housing 9 for example can further comprise a mount 58 for mounting the security system 1 to a clamp or other mating feature of an object to be protected or near an object to be protected. For example, the mount can be used to attach the present security system 1 to the back of a truck. The ability to attach the present security system 1 to a rigid mounting bracket is also advantageous in that a security system 1 mounted in this way is generally subject to less vibration and therefore will provide fewer false alarms. User information labels 57 can also be placed on top of the beacon cover 13 and in other locations in order to provide information to a user.

Additional Sensors

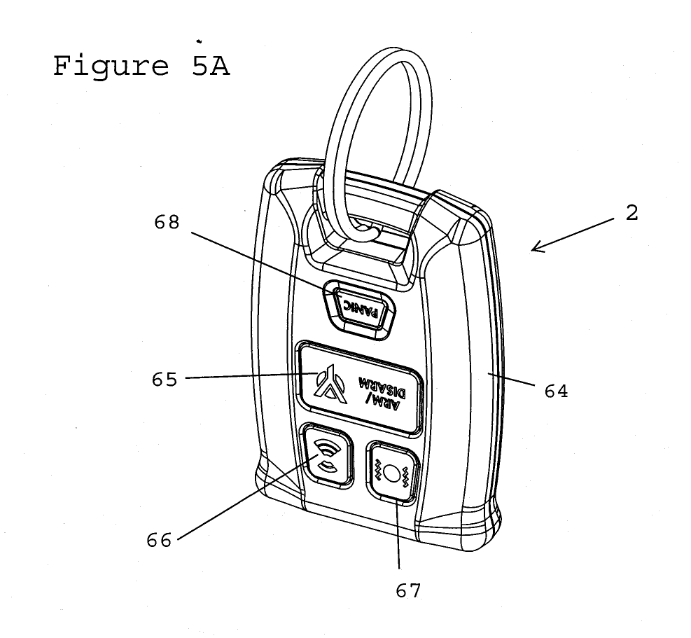

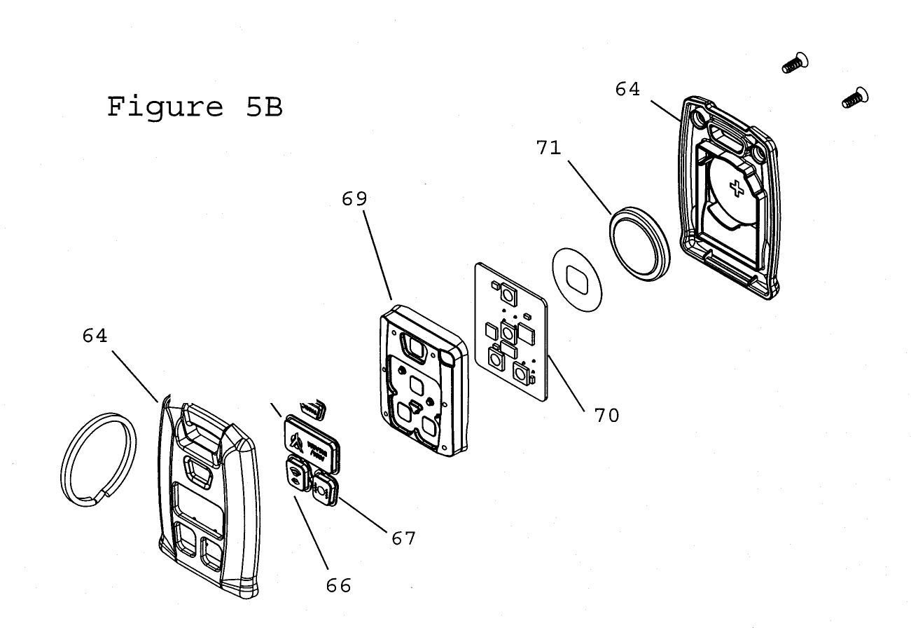

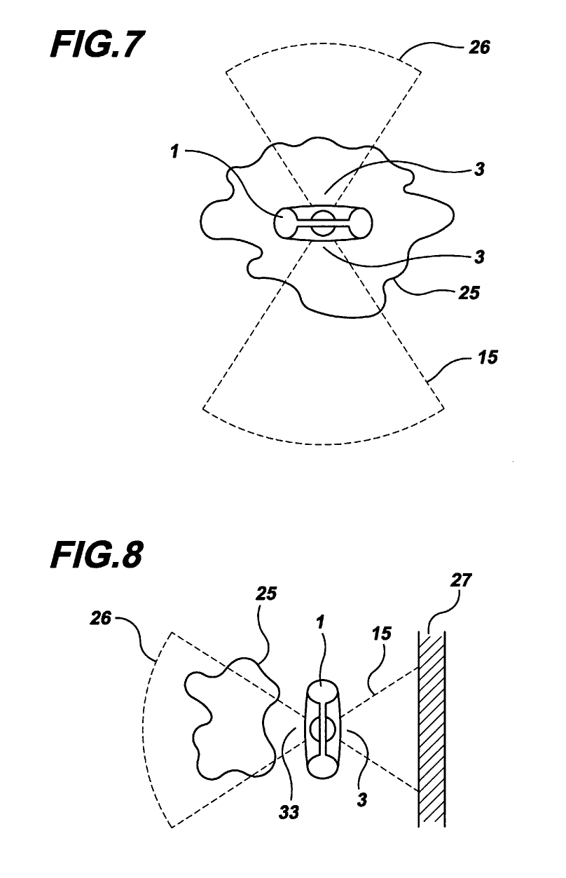

The security system 1 can also contain a rear passive infra-red sensor 33 that is located on the rear face 104 of the unit in addition to the infra-red sensor 3 located on the front face 102 of the housing 9. A rear passive infrared motion sensor 33 can be positioned in window 105 of the rear face 104 of the housing 9, while the front passive infrared motion sensor 3, preferably a longer range sensor, is positioned in window 103 in the front face 102 of the housing 9. The region where motion can be detected 26 using this additional sensor is shown in FIG. 7. The detection region 26 is preferably smaller in terms of distance and/or angular range than that of the front infra-red sensor 3, in order to provide greater flexibility in the use of the present system. The regions 15 and 26 can be asymmetric to increase the number of ranges available. The angular range and distance are defined by the characteristic shape of the fresnel lens on the passive infra-red sensors.

In situations where the material to be protected 25 is in an open area such as a field, the security system 1 should be placed on top of or among the material 25 as shown in FIG. 7. Activation of either of the passive infra-red sensors (3 or 33) will cause an alarm. When shorter range detection is desired, the security system 1 can be placed such that the detection region 15 is pointed into a barrier such as a wall 27. This effectively limits the range of sensitivity of the security system 1 with minimal cost since no electronic user controls are required.

This sensitivity range control is especially important when the security system 1 is used in a truck bed. It is desirable to limit the number of false alarms in this application, for example when a truck is in a parking lot. In this case the security system 1 could be placed behind the cab with the longer range detection region 15 pointing toward the front end of the vehicle.

In one embodiment, the security system 1 can contain an electric field detection circuit that allows an electrode to be connected to the barrel jack 18. This jack is also used to allow the connection of an external power source to recharge the battery 8. Using a single jack for both purposes reduces cost and simplifies the connection for the user. An electrode 28 connected to the security system 1 through the barrel jack 18 can be any insulated metallic object such as a wire, wire mesh, or a metalized cloth. The security system 1 applies a sinusoidal, voltage to the electrode at a frequency preferably around 120 kHz. A resistor 30, approximately 22,000 ohms, is connected between the voltage source 29 to the barrel jack 18. The sensor is activated when the RMS voltage drop across the resistor 30 changes significantly. The security system 1 is coupled to the earth ground through a direct or capacitive connection. The change in voltage drop will occur when an object that is also coupled to earth ground moves in the proximity of the electrode 28. The electric field surrounding the electrode 28 is effectively shorted out when an object moves in the proximity of the electrode 28.

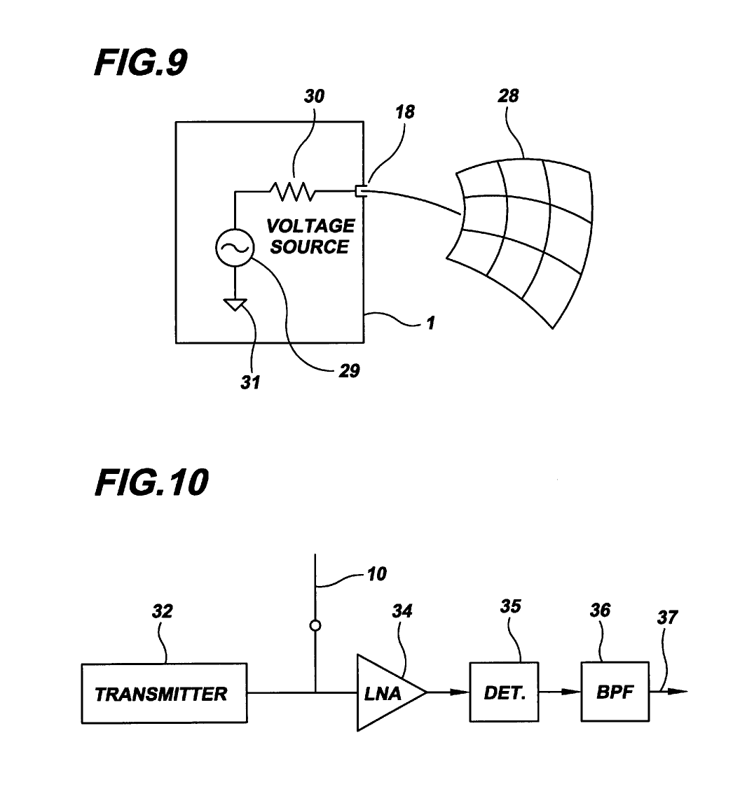

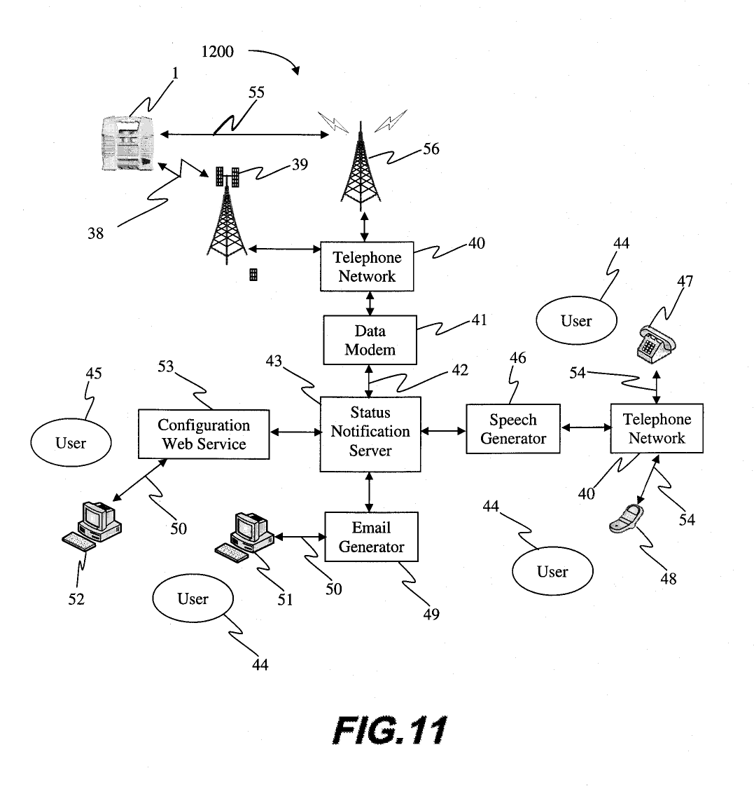

The security system 1 can also contain an omnidirectional, microwave detector. The detector can use the antenna 10 as well as part of the electronics associated with the RF communications radio for the microwave detector as shown in FIG. 10. The internal electronics 7 of the present system 1 contains a transceiver that preferably operates at approximately 915 MHz for communication with the alarm remote 20, the automatic remote 24, and/or with other security systems 1. The use of the 915 MHz communications transceiver significantly reduces the cost associated with the microwave detector since only the receiver portion need be added. The transceiver contains a transmitter and a receiver that are controlled by the microprocessor of the present system 1. When used for microwave detection, the communications transmitter drives antenna 10. Signals reflected from stationary objects have a frequency that is the same as the transmitted frequency, while signals reflected from moving objects have a different frequency, generally in the range of 10 to 40 Hz, as a result of a Doppler frequency shift. The reflected signal and the transmitted signal are summed at the antenna 10 and this combination is amplified by a low-noise amplifier 34. The two signals with slightly different frequencies beat against each other such that the resultant signal appears as an amplitude modulated signal. This modulated signal is detected using a RF detector 35 and connected to a band-pass filter 36. The band-pass filter attenuates frequencies above and below a predetermined threshold, such as above 40 Hz and below 10 Hz. The amplitude of the signal at 37 is routed to the microprocessor for measurement to determine if the magnitude is sufficient to activate the alarm. Depending on the signal strengths used, a duplexer can be used to couple the low-noise amplifier 34 to the antenna 10 and thereby reduce the magnitude of the signal from the transmitter 32.

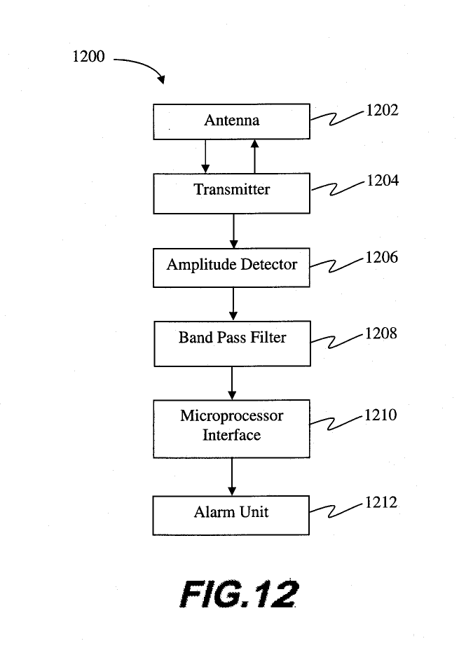

Referring now to FIG. 12, there is shown a block diagram of a microwave sensor 1200 according to one embodiment of the present invention. The microwave sensor can comprise an antenna 1202, a transmitter 1204, an amplitude detector 1206, a band pass filter 1208, a microprocessor interface 1210 and an alarm unit 1212. In another embodiment, the microwave sensor 1200 further comprises an analog to digital converter (not shown). In a preferred embodiment, the transmitter 1204 and the antenna 1202 perform two functions. The first function is the microwave sensor and the second function is communications to externally attached accessories to reduce the cost of the unit. In one embodiment, when the microwave sensor is running the transmitter 1204 is pulsed on at a rate of at least 80 pulses a second but preferably 400 pulses per second. Additionally, the pulses activate the analog to digital converter (not shown) to sample the received signal frequency 10 times per cycle of the alternating current waveform that is output from the band pass filter 1208. The output from the band pass filter 1208 is sent to the microprocessor interface 1210 to be analyzed. If the coded algorithms of the microprocessor interface 1210 detect an intruder in the area, the microprocessor interface 1210 activates the alarm unit 1212.

In one embodiment, the frequency of the transmitter is between 900 Mhz and 6 Ghz. In one embodiment, the sum of the outgoing transmitted signal frequency and reflected signal frequency containing a slightly shifted frequency is equivalent to the transmitted signal amplitude modulated by a signal that is the difference between the transmitted and reflected frequencies. The amplitude detector removes the transmitted signal and leaves only a signal where the frequency is the difference between the transmitted and reflected signals and the amplitude which related to the amplitude of the reflected signal. This is commonly referred to as amplitude demodulation.

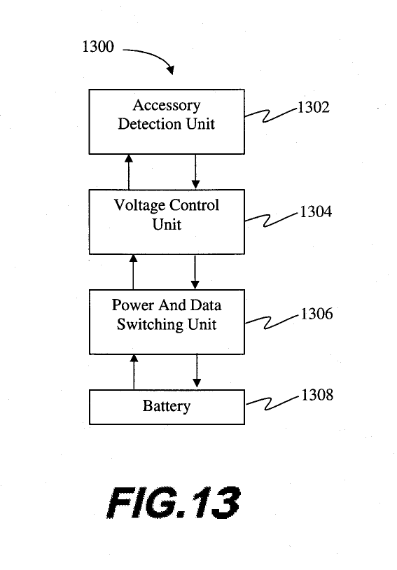

Referring now to FIG. 13, there is shown a block diagram of a battery charging and communications circuit 1300 according to one embodiment of the present invention. The charging behavior can be performed when ever a power source is connected to the voltage control unit 1302 depending on the discharge condition of the battery 1308. In a preferred embodiment, a lead-acid battery 1308 is provided. In another embodiment, the charging circuit 1300 will apply a constant current through the voltage control unit 1304 of approximately 700 mA until the applied voltage reaches 14.75 volts. The voltage is held constant by the voltage control unit 1304 at 14.75 volts until the current drops below 70 mA. At this point, the voltage control unit 1304 provides a trickle charge at a constant voltage of about 13.65 volts. In another embodiment, the power and data switching unit 1306 alternately switches between passing power (voltage and current) from the voltage control unit 1304 and passing communications data to the microprocessor interface 1210. In one embodiment, the communications data is a digital signal carried on an alternating current. In a preferred embodiment, the communications data is digital only.

Additional types of detectors can also be used in connection with the present system. For example, smoke detectors and thermal detectors can be housed in the housing 9. Thermal sensors are generally activated when the temperature is measured to be above a predetermined level. A video camera can also be included in the present system, for use both in detecting an intruder and in capturing images of the intruder. In one embodiment, such images can be sent wirelessly to a remote viewer, such as to a cell phone with a screen or via the internet.

Remote Communications

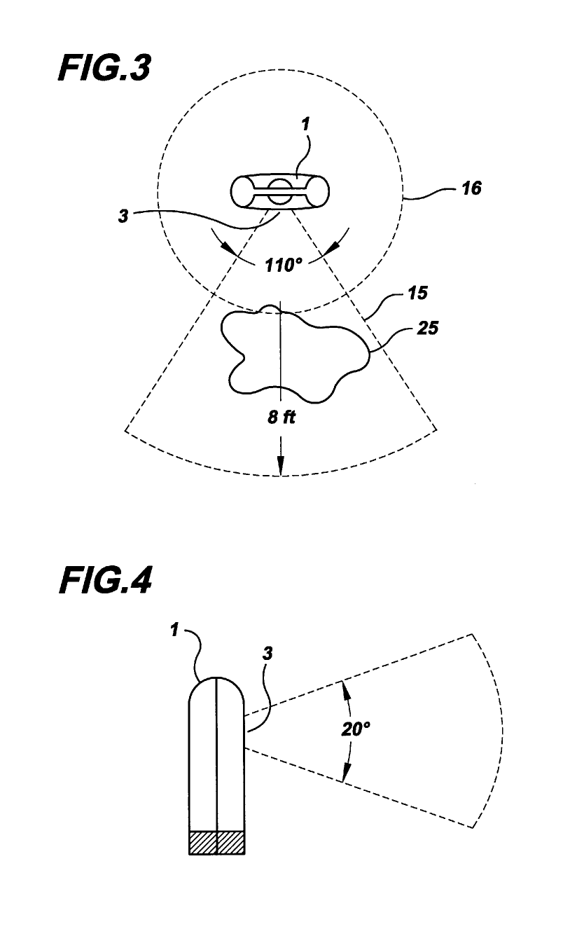

The remote key fob 2 is a small, handheld device, which can have one or more buttons 19. The device contains an transmitter or transceiver along with a microprocessor, an antenna, and a small coin cell battery. The key fob 2 communicates with the security system 1, preferably over radio frequencies though other communications frequencies, such as infra-red communication link, can also be used. In a preferred embodiment, the present security system is operable only from the key fob 2, and the control panel 6 only contains indicators and does not contain sensor selection buttons. The preferred embodiment for key fob 2 thus includes all of the controls necessary to select sensors which the self-contained security system will use to detect an intruder. As shown in FIGS. 5A and 5B, the key fob 2 preferably contains an arm/disarm button 65, an accelerometer selection/deselection button 67, a passive infrared sensor selection/deselection button 66, and a panic button 68 (to activate one or more of the alarms). FIG. 5 illustrates the internal components of the key fob 2, including a housing 64 having front panel 64a and rear panel 64b, a rubber boot 69, preferably made from silicone rubber to limit the intrusion of water and dust into the key fob 2, a printed circuit board 70 containing the electronics of the key fob 2, and a battery 71, such as a lithium battery.

It is advantageous to have remote notification of sensor activation, such as through an indicator provided on key fob 2, since the alarms of the present security system may not be discernible from where a user is positioned. It is also not always possible or desirable to sound an alarm siren. For example, at a campground it would be undesirable to disturb the peaceful environment with a high intensity audible siren. It is an additional advantage that the overall operational status of the present security system can reported remotely to confirm that it is in a satisfactory condition to alarm or notify the user of sensor activation. Remote status notification can be implemented in various ways. In a preferred embodiment, a point-to-point, two-way radio communication link between the present system 1 and a remote device such as a key fob 2 is used to alert the user of sensor activation and/or to indicate the operational status of the present security system 1. Alternatively, the security system 1 can be constructed to include circuitry that utilizes an existing communications network such as cellular telephone or two-way pager messaging mechanisms to provide remote status notification.

A point-to-point radio link involves the use of the security system 1, preferably with an RF power amplifier and a high-gain amplifier to extend the communications range. In the ISM (Industrial, Scientific and Manufacturing) radio bands the FCC allows a maximum transmitter power to be 1 watt if spread-spectrum techniques are employed. The maximum allowable antenna gain is 6 dB. For maximum range, both the maximum power and maximum antenna gain are preferred. The Texas Instruments CC1100 transceiver is employed to facilitate packetized communications protocols with rapid spread-spectrum, frequency hopping. An alarm remote 20 also preferably contains a RF power amplifier and antenna configured for maximum range.

The security system 1 can alternatively be used with an alarm remote 20 shown in FIG. 5. The alarm remote 20 alerts the user when it receives an RF transmission from the security system 1 when a sensor has been activated. The alarm remote 4 has an antenna 21, an alarm light 22, a buzzer 23, as well as an arm/disarm button 19. The antenna 21 is included to allow sufficient reception so the distance between the security system 1 and the alarm remote 20 can be beyond 1000 feet. The alarm light 22 and the buzzer 23 are activated when the alarm remote 20 receives an alarm notification from the security system 1. The operation of the arm/disarm button 19 is identical to the operation of this button on the remote key fob 2.

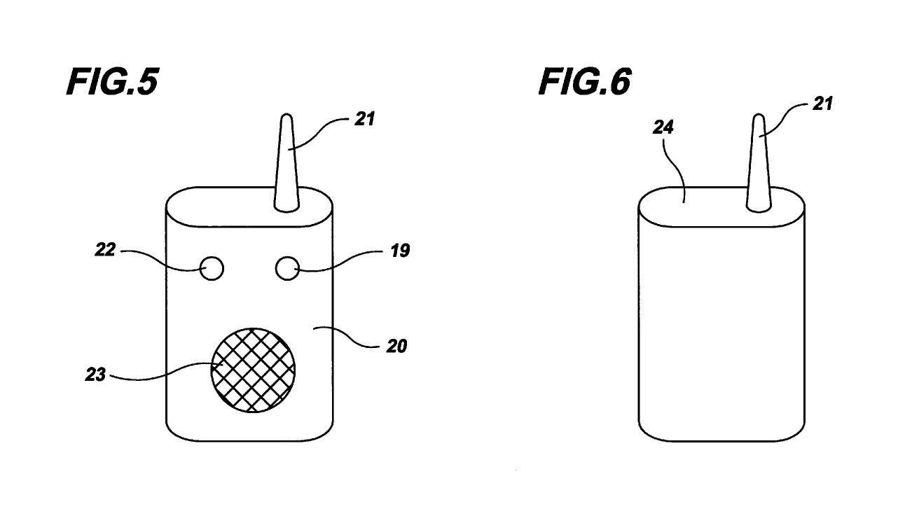

The security system 1 can alternatively be used with an automatic remote 24 shown in FIG. 6. The automatic remote 24 transmits an RF signal that disarms the activation of the beacon 4 and the siren 5 on the security system 1 when it is moved into its range of radio reception. The security system 1 is armed when it no longer receives the RF signal from the automatic remote 24. The automatic remote 24 has an enclosure containing a battery and internal electronics. It has an external antenna 21 to enhance the communication range, but does not require any user controls.

The automatic remote 24 allows a user to freely move in and out of an area that is protected by the security system 1 without activating the alarm.

Cellular Telephone Communications Network

In an alternate embodiment of the present system, the security system 1 can contain the radio circuitry that can place a cellular telephone call upon activation of a sensor. The cellular radio transmission 38 containing the sensor activation status is received by cellular tower 39 where the call enters the existing world-wide telephone network 40. The call is routed to a data modem 41 where the telephony signal is converted to a digital format that can be handled by the status notification server 43. The status notification server 43 is a general purpose computer server with software that accepts security system notification messages and generates human notifications. The behavior of the status notification server 43 is configured by a configuration user 45 using an internet based computer 52 via internet link 50. A web service 53 can comprise a configuration web page with an interface to the status notification server 43. Using this mechanism the configuration user 45 can decide what to do when a sensor is activated at security system 1 some time in the future. Alternatively or in addition, the status notification server 43 can be configured via a Touch-tone™ telephone.

The status notification server 43 can be configured to generate a speech message using the speech generator 46 which will place a second telephone call 54 to a user 44 by either a conventional telephone 47 or to a cellular telephone 48. The status notification server 43 can also be configured to generate an email message using email generator 49 which sends an email message to a user's computer 51 to be read by user 44. Additionally, notifications can be configured to generate text messages such as SMS messages.

A user of the security system 1 need only own the security system 1. All other communications infrastructure is generally owned by a service provider that may charge a monthly or per call fee to notify the user of sensor activation.

Two-way Pager Communications Network

In another embodiment of the present system, the security system 1 can contain radio circuitry that can initiate a two-way pager message transfer 55 to a two-way pager base station 56. The two-way pager message is text based and is routed through a conventional telephone network 40. The configuration and notification methods described above can be used.

Security Groups

The point-to-point radio link method of providing a remote status notification described above generally has a range of hundreds of feet to up to 10 miles under ideal conditions. The notification described above is for a security system 1 that is associated with an alarm remote 20 on a one-to-one basis. The one-to-one association between the security system 1 and alarm remote 20 does not allow a second, non-associated, alarm remote 20 to control or disable the security system 1.

In a further embodiment, the alarm remote 20 can also provide an additional indicator that shows when one or more non-associated security systems 1 are within radio range of the alarm remote 20. This additional indicator can flash and/or a buzzer 23 can be made to sound if a non-associated security system sensor is activated. This feature allows a “neighborhood watch” type capability where groups of security conscience individuals are all made aware if any security system 1 is activated. This feature can be disabled if the individual does not want to participate in a security group or allow their security system 1 to appear as a non-associated security system to another user's alarm remote 20.

System Operation

Using the key fob 2, the user selects the type of sensors to use and places the unit in a position in the vicinity of the user's valuables 25, such that the passive infra-red or the microwave sensors will be activated if an intruder approaches the system within the respective regions of sensitivity, 15 and 16. Prior to arming the system, i.e. turning on one or more of the sensors, the beacon 4 preferably flashes to indicate to the user that a sensor has been activated. In this way, the user can test and confirm the proper placement of the unit with respect to an object to be protected. Once the unit is properly placed, the user presses the button 19 on the remote key fob 2 to arm the unit. The unit chirps the siren to confirm to the user that the system has been successfully armed.

At this point, the security system 1 interrogates the sensors to determine the presence of an intruder. If the passive infra-red motion detector (3 or 33) or the accelerometer are activated the security system 1 flashes the beacon 4 and turns on the siren 5, preferably for a predetermined period, preferably approximately 3 minutes. After this period the unit returns to the armed condition, waiting for a sensor to be activated again. If the user depresses the button 19 on the remote key fob 2 while in range of the unit, the system turns off after it chirps the siren, once again to confirm that the unit has been deactivated.

The security system 1 contains multiple sensors. Each sensor may be activated independently or multiple sensors can be activated when an intruder approaches. For example, both the microwave and passive infra-red sensors would likely be activated simultaneously when an intruder approaches. However, the accelerometer would only be activated when the security system 1 is bumped or moved.

The security system 1 can be electronically configured to activate the alarm when any of its sensors are activated or only when a combination of its sensors are activated. Activating the alarm when any sensor is activated makes the system most sensitive but also increases the likelihood of a false alarm. Activating the alarm only when multiple sensors are activated reduces the probability of a false alarm.

A group of two or more security systems 1 can also be used in a coordinated fashion. When a sensor on a particular security system 1 is activated, it can transmit an RF signal to the other security systems 1 within its radio range. If units are positioned at a distance outside of each other's range, a second unit can relay the signal, i.e. send out a signal in response to a signal from a first unit. The group of security systems can be electronically configured to activate their alarms simultaneously when any unit is activated or only when multiple units are activated. Activating the alarms simultaneously when any unit is activated makes the system most sensitive but also increases the likelihood of a false alarm. Activating the alarms simultaneously only when multiple units are activated reduces the probability of false alarms.

Additionally, the remote key fob 2 can arm and disarm a group of two or more security systems 1 simultaneously. When configured for this mode, each system relays the arm or disarm command from the remote key fob to all of the units within radio range.

Applications

The present security system 1 is useful in a wide variety of applications. Building contractors can use the present system for example to protect a collection of tools on a job site that are left overnight. Tools and other valuables left in a truck bed can likewise be protected by placing the present system on or near such valuables.

The present system is also useful in outdoor recreation venues. It can provide peace of mind to campers and RV owners while they are away from their campsite, for example, and can ensures that skis and other boat contents are not stolen from boats or boat docks.

In addition, the present system can be used in a home environment, where it can sounds an alarm when children enter a region of potential danger where the present system has been set up. In an alternative embodiment, the siren of the present system can be an ultrasonic siren, in which case the present system can be positioned in areas where deer or roaming domestic animals are not desired, such that animals will be deterred by the ultrasonic siren if they venture in the area where it is positioned.

### EXAMPLE

In one embodiment, the present portable security system can be approximately 10 inches long, 4 inches wide and 10 inches tall and can weigh approximately 8 pounds. This security system 1 is illustrated in FIGS. 2-2B and comprises a passive infra-red motion sensor 3, a flashing beacon 4, a high intensity siren 5, a control panel 6, internal electronics 7, and a rechargeable battery 8, all enclosed in the housing 9 which further comprises a handle 11.

Although the present invention has been discussed in considerable detail with reference to certain preferred embodiments, other embodiments are possible. The steps disclosed for the present methods are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. A self-contained, portable security system comprising:
(a) a housing unit comprising:
a housing;
a plurality of sensors in the housing for detecting an intruder within a security region around an object exterior to the housing, wherein the sensors are selected from the group consisting of an infra-red sensor, an accelerometer, a microwave motion sensor, an electric field detector, a thermal sensor, and a video camera; and
one or more alarms in the housing selected from the group consisting of a visual alarm and an audible alarm; and
(b) an electronic key fob for remotely disarming the one or more alarms.

2. The security system of claim 1, wherein the sensors are positioned in an upper portion of the housing.

3. The security system of claim 1, wherein the center of gravity of the security system is in a lower portion of the housing.

4. The security system of claim 1, further comprising a clamp mount for coupling the housing to the object.

5. The security system of claim 1, further comprising a handle on the housing.

6. The security system of claim 5, wherein the handle is reversibly secured to the housing.

7. The security system of claim 1, further comprising:
a first infra-red motion sensor, the first infra-red motion sensor having a first detection region extending outward from a front face of the housing; and
a second infra-red motion sensor, the second infra-red motion sensor having a second detection region extending outward from a rear face of the housing.

8. The security system of claim 1, wherein the electronic key fob includes an indicator of the activation status of one or more of the sensors.

9. The security system of claim 1, wherein the activation status of one or more of the sensors is communicated from the housing unit to the remote key fob via a radio frequency communication link.

10. The security system of claim 1, wherein the electronic key fob automatically disarms the one or more alarms when it is within a predetermined distance from the housing unit.

11. The security system of claim 1, wherein the electronic key fob includes an indicator that a second security system is within radio communication range.

12. The security system of claim 1, wherein the electronic key fob includes an indicator of the activation status of a sensor of a second security system.

13. A self-contained, portable security system comprising one or more sensors, one or more alarms triggered by the sensors, and a battery, the battery having an upper surface, a lower surface, and side surfaces, wherein the system further comprises:
a housing containing the sensors, the alarms and the battery, the housing having an interior surface and an exterior surface;
a battery holder for retaining the battery in a lower portion of the housing, the battery holder having an interior surface and an exterior surface, wherein the interior surface engages the upper surface and the side surfaces of the battery; and
a plurality of ribs extending between the interior surface of the housing and the exterior surface of the battery holder to restrain movement of the battery within the housing.

14. The security system of claim 13, wherein the one or more sensors comprise a sensor selected from the group consisting of an accelerometer, a microwave motion sensor, an electric field detector, a thermal sensor, a smoke detector, and a video camera.

15. A self-contained, portable security system comprising one or more sensors, wherein the system further comprises:
a housing containing the sensors, the housing having a top, a bottom, a front face, a rear face, and two lateral sides;
a beacon located on the top of the housing between the two lateral sides of the housing, wherein the beacon is visible from both the front face and the rear face of the housing when activated; and
a rigid handle extending over the beacon and between the two lateral sides of the housing to protect the beacon from an impact.

16. The security system of claim 15, wherein the one or more sensors comprise a sensor selected from the group consisting of an accelerometer, a microwave motion sensor, an electric field detector, a thermal sensor, a smoke detector, and a video camera.

17. The security system of claim 15, wherein the beacon is protected by a translucent cover.

18. The security system of claim 15, wherein the system has a center of gravity in a lower portion of the system.

19. A self-contained, portable security system for detecting an intruder within a security region around an object exterior to the system, comprising:
a housing having a front face and a rear face;
a first infra-red motion sensor, the first infra-red motion sensor having a first detection region extending outward from the front face of the housing; and
a second infra-red motion sensor, the second infra-red motion sensor having a second detection region extending outward from the rear face of the housing,
wherein the first detection region and the second detection region are asymmetric.

20. The security system of claim 19, one or more alarms in the housing selected from the group consisting of a visual alarm and an audible alarm.

21. The security system of claim 19, wherein the system comprises a further sensor selected from the group consisting of an accelerometer, a microwave motion sensor, an electric field detector, a thermal sensor, a smoke detector, and a video camera.

22. A method of using a security system, comprising the steps of:
(a) providing a first portable security system and a second portable security system, each system comprising:
a housing;
a plurality of sensors in the housing for detecting an intruder within a security region around an object exterior to the housing, wherein the sensors are selected from the group consisting of an infra-red sensor, an accelerometer, a microwave motion sensor, an electric field detector, a thermal sensor, and a video camera; and
one or more alarms in the housing selected from the group consisting of a visual alarm and an audible alarm;
(b) activating an alarm of the first security system when one or more sensors of the first security system are activated; and
(c) transmitting a communication signal directly from the first portable security system to the second portable security system to activate an alarm of the second portable security system.

23. The security system of claim 22, wherein step (c) occurs only if more than one sensor of the first portable security system is activated.

24. A method of using a security system, comprising the steps of:
(a) providing a portable security system comprising:
a housing;
a plurality of sensors in the housing for detecting an intruder within a security region around an object exterior to the housing, wherein the sensors are selected from the group consisting of an infra-red sensor, an accelerometer, a microwave motion sensor, an electric field detector, a thermal sensor, and a video camera; and
one or more alarms in the housing selected from the group consisting of a visual alarm and an audible alarm;
(b) sending a communication signal from the portable security system to a status notification server when one or more sensors of the first security system are activated;
(c) generating a message in response to the communication signal from the portable security system; and
(d) sending the message to a user of the portable security system.

25. The security system of claim 24, wherein the communication signal from the portable security system to the status notification server is sent via a cellular communications network.

26. The security system of claim 24, wherein the communication signal from the portable security system to the status notification server is sent via a two-way pager base station.

27. The security system of claim 24, wherein the message is a text message.

28. A microwave sensor comprising:
a) a transmitter;
b) an antenna connected to the transmitter;
c) an amplitude detector electrically connected to the antenna;
d) a band pass filter electrically connected to the amplitude detector; and
c) a microprocessor interface electrically connected to the transmitter, the antenna, the amplitude detector and the band pass filter.

29. The microwave sensor of claim 28, where the microprocessor interface comprises an analog-to-digital converter.

30. The microwave sensor of claim 28, where the transmitter and the antenna transmit microwave detection signals, transmit communications signals or both transmit microwave detection signals and transmit communications signals.

31. The microwave sensor of claim 28, where the transmitter is pulsed at a rate at least between 80 pulses a second and 1000 pulses a second.

32. The microwave sensor of claim 28, where the antenna is selected from the group consisting of a dielectric resonator antenna, a dipole antenna, an electrically short antenna, a feed horn antenna, a helical antenna, a large loop antenna, a microstrip antenna, a parabolic antenna, a phased array antenna and a small loop antenna.

33. The microwave sensor of claim 28, where the microwave frequency received by the antenna is a continuous wave.

34. The microwave sensor of claim 28, where the microwave frequency received by the antenna is between 900 Mhz and 6 Ghz.

35. The microwave sensor of claim 28, where the microprocessor interface sums a digital sample frequency with a received digitally converted microwave frequency.

36. The microwave sensor of claim 28, where the band pass filter outputs a signal between 1 VAC and 12 VAC.

37. A battery charging and communications circuit comprising:
a) an accessory detection unit;
b) a voltage control unit electrically connected to the accessory detection unit;
c) a power and data switching unit electrically connected to the voltage control unit; and
d) a battery.

38. The battery charging and communications circuit of claim 37, where the accessory detection unit transmits data to one or more accessories attached to the circuit.

39. The battery charging and communications circuit of claim 37, where the accessory detection unit receives data from one or more accessories attached to the circuit.

40. The battery charging and communications circuit of claim 37, where the accessory detection unit transmits power to one or more accessories attached to the circuit.

41. The battery charging and communications circuit of claim 37, where the voltage control unit supplies an input voltage, an input current, an output voltage and an output current to the battery charging and communications circuit; and where the input voltage, the input current, the output voltage and the output current are selected from the group consisting of an externally supplied alternating current, an externally supplied direct current and an internally supplied direct current.

42. The battery charging and communications circuit of claim 37, where the voltage control unit is forward biased to select a higher input voltage to supply the circuit.

43. The battery charging and communications circuit of claim 37, where the voltage control unit comprises an electronic switch to select the input voltage and the input current to operate the circuit and attached accessories.

44. The battery charging and communications circuit of claim 37, where the battery charge sensor transmits a signal to the voltage control unit when the rechargeable battery is fully charged.

45. The battery charging and communications circuit of claim 37, where the battery charge sensor transmits a signal to the voltage control unit when the rechargeable battery is connected to an external power source.
